(19) United States
(12) Patent Application Publication
(10) Pub. No.: US 2023/0330926 A1
(43) Pub. Date: Oct. 19, 2023

(54) Method for Producing a Component, and Component

(71) Applicant: ams-OSRAM International GmbH, Regensburg (DE)

(72) Inventor: Matthias Hien, Kirchroth (DE)

(21) Appl. No.: 18/044,524

(22) PCT Filed: Oct. 6, 2021
(86) PCT No.: PCT/EP2021/077528

§ 371 Date: Mar. 8, 2023

(30) Foreign Application Priority Data
Oct. 8, 2020 (DE) 102020126432.1

(51) Int. Cl. B33Y 10/00; B29C 64/135; B29C 64/268; B33Y 80/00

(52) U.S. Cl. CPC B29C 64/135; B29C 64/268; B33Y 10/00; B33Y 80/00

(57) ABSTRACT

In an embodiment a method for producing a component having a main body, an electrode structure configured for electrically contacting the main body and a housing body bordering the main body and the electrode structure includes providing a container with a liquid solution located therein, wherein the liquid solution includes a light-curing material, and wherein the main body and the electrode structure are disposed in the container and surrounded by the liquid solution, and focusing, by a two-photon lithography, photons on targeted local points on the main body and on the electrode structure thereby polymerizing and curing the solution and forming the housing body.

This patent application is a national phase filing under section 371 of PCT/EP2021/077528, filed Oct. 6, 2021, which claims the priority of German patent application 10 2020 126 432.1, filed Oct. 8, 2020, each of which is incorporated herein by reference in its entirety.

### TECHNICAL FIELD

An efficient method is specified for producing a compact component. Further specified is a compact and mechanically stable component produced in particular by the method described here.

### BACKGROUND

The development of the methods known as additive manufacturing is continually increasing and, in light of the demand and the requirement for continual improvement in terms of the speed and the accuracy, the systems for applying additive layers ought to operate even more effectively and more quickly. It is desirable, moreover, that the systems of such manufacturing methods operate with the maximum of precision and economy of materials.

### SUMMARY

Embodiments provide an efficient, exact, and reliable method for producing a compact component. Further embodiments provide a compact and mechanically stable component.

According to at least one embodiment of a method for producing a component, a container is provided which has, located therein, a liquid solution. The solution comprises a light-curing material. Such a material is in particular a photosensitive material which is located in a liquid solution, for instance in a viscid or sol-like solution. The solution may be a resin-initiator mixture. For example, the light-curing material is a polymer such as photopolymer or acrylic, epoxy or vinyl ester resin. If the solution is irradiated with light, more particularly with laser light, the material is able to absorb energy sufficiently, in the form of photons, for instance, causing the material to be polymerized and cured.

According to at least one embodiment of the method, a main body and an electrode structure are disposed in the container. In particular the main body is disposed on the electrode structure and it has mechanical and electrically conducting connection to said structure. It is possible for the main body and the electrode structure to be immersed into the solution, for instance fully immersed into the solution. Alternatively it is possible first for the main body and the electrode structure to be disposed in the container, before the container is filled up with the liquid solution. The container may comprise a carrier structure for accommodating the main body and/or the electrode structure.

According to at least one embodiment of the method, the main body and the electrode structure are disposed in the container and surrounded by the liquid solution, more particularly surrounded completely in lateral and vertical directions. A housing body of the component to be produced is manufactured by means of two-photon lithography, i.e., by means of two-photon polymerization technique. With this technique, photons are focused in a targeted way on predefined local points on the main body and on the electrode structure, with the light-curing material located in the solution being thereby polymerized and cured at the focused local points to form the housing body. The photons may come from two different photon sources or from a single photon source. The completed component thus comprises a main body, an electrode structure configured for electrically contacting the main body, and a housing body bordering the main body and the electrode structure.

A lateral direction is understood to mean a direction which in particular runs parallel to a principal extent face of the component, more particularly parallel to a principal extent face of the main body of the component. A vertical direction is understood to mean a direction which in particular is oriented perpendicularly to the principal extent face of the component or of the main body of the component. In particular, the vertical direction and the lateral direction are orthogonal to one another.

In the case of two-photon lithography, photons for instance from two photon sources, more particularly from two laser sources, are used, or are focused from a single photon source, in order to trigger a chain reaction in the liquid solution, more particularly in the resin-initiator mixture. With this technique, the photons can be focused in such a way that the light-curing material absorbs two high-energy photons simultaneously or substantially simultaneously, thereby triggering the chain reaction in the liquid solution and hence the polymerization. The starting point for the polymerization can be chosen as desired as a function of the focusing of the photons or of the light beams.

In other words, the absorption of two photons provides sufficient energy to initiate the polymerization. If the two light beams impinge on one another in the 3D space, the light-curing material begins to cure and to solidify. In this way the electrode structure, which more particularly is a leadframe, and/or the main body may be immersed completely into the liquid solution, with the entire housing body being generated around the main body and/or around the electrode structure without the main body and/or the electrode structure being contacted during the operation of producing the housing body. There is no need for a prefabricated mold or mask in order to produce the housing body.

The photon source or the photon sources may be driven and focused in such a way —whenever and wherever the material located in the solution is to be cured — in order to produce the housing body with any desired shape. The use of individual photon sources, more particularly of pairs of photon sources, from all possible directions, for instance, enables the curing of the material which in the normal case from above or from below is unachievable or achievable only with difficulty by means of conventional techniques. Two-photon lithography is therefore particularly suitable for forming a housing body around an electrode structure, especially with half-etched leadframes, or around an electrode structure with local indentations or elevations, or around an electrode structure having curved or angled surfaces.

According to at least one embodiment of the method, the main body comprises a semiconductor body. It is possible for the main body itself to be a semiconductor body. The component to be produced is more particularly an optoelectronic component. For example, the semiconductor body has a first semiconductor layer, a second semiconductor layer, and an active zone disposed between the semiconductor layers. In the operation of the component, the active zone is configured in particular to generate or to detect electrical radiation, in the visible, ultraviolet or the infrared spectral range, for instance. In a departure from this, it is possible for the main body not to be configured to generate or detect electromagnetic radiation. For example, the main body is different from a semiconductor body or has no such semiconductor body. The main body may be an electronic component. For example, the main body comprises integrated circuits and may be an IC chip, more particularly a control chip.

In at least one embodiment of a method for producing a component which comprises a main body, an electrode structure configured for electrically contacting the main body, and a housing body bordering the main body and the electrode structure, a container is provided, having a liquid solution located therein. The solution comprises a light-curing material, the main body and the electrode structure being disposed in the container and being surrounded by the liquid solution. The housing body is manufactured by means of two-photon lithography, in which photons are focused on targeted local points on the main body and on the electrode structure, with the light-curing material located in the solution being thereby polymerized and cured at the focused local points to form the housing body.

In order to form the housing body, accordingly, a so-called two-photon polymerization technique is proposed, 2PP, this being a technology that uses a photon source or two photon sources, more particularly two laser sources, to cure a light-curing material, such as an epoxy or acrylate material, for instance. The underlying basic principle is two-photon absorption, in which two photons are absorbed in particular simultaneously by a molecule or an atom which undergoes transition, in the process, to an energetically excited state. The energy of one of these photons itself would generally not be sufficient to bridge the energy difference between a ground state and the excited state.

With this method, the system in question is in particular what is called a real 3D system, since the method is capable of initiating the construction and the curing of a housing body virtually in a 3D space without the need in particular to use additional carrier layers. Through focusing of the photons it is possible to grow the housing body at any desired location in the liquid solution. In other words, the starting point for the formation of the housing body can be chosen arbitrarily - for instance, directly on the main body or on the electrode structure or in the vicinity of the main body or the electrode structure.

In comparison to existing standard methods such as FAM (foil assisted molding) or injection molding, the two-photon polymerization technique does not require any specific and relatively expensive tools. Moreover, the housing body is formed only at exactly the location where it is actually intended, and so no material or hardly any material of the housing body is consumed unnecessarily. With this technology it is possible to generate the housing body in any desired shape and at any desired point in the vicinity of the main body and/or the electrode structure.

According to at least one embodiment of the method, the light-curing material comprises monomers of a light-curing polymer, such as base monomers of a photopolymer. The liquid solution is in particular an acrylic resin, epoxy resin or vinyl ester resin solution. The solution may comprise additional constituents, such as initiators, which trigger chain reactions for polymerizing the light-curing material. The monomers are able to attach to the initiators and form polymer chains.

According to at least one embodiment of the method, the main body and the electrode structure are surrounded completely by the liquid solution. In particular the housing body is formed without additional auxiliaries, such as without additional supporting structures, exclusively by focusing of the photons at targeted local points. The only supporting structure, however, may be a carrier structure located at least partially in the container, on which the main body and the electrode structure are disposed in particular before the housing body is generated.

In comparison to a standard polymerization technique, such as VAT or SLA polymerization technique, for example, in which the housing body after each step is lowered a bit deeper into the liquid and is returned to a position in order to form a sublayer of the housing body, in the case of the two-photon polymerization technique the housing body can be located completely in the liquid solution throughout the production operation. The housing body is therefore constructed by focusing sites which materialize freely in the space. In comparison to the standard polymerization technique, the housing body can be free from a layer sequence composed of parallel sublayers which in particular are planar and disposed one above another. Instead, the housing body produced by two-photon polymerization technique may have regions directly adjacent to one another, more particularly clump-like regions which have grown onto one another or over one another.

According to at least one embodiment of the method, a carrier structure having an opening is located in the container. The main body and the electrode structure are disposed more particularly on the carrier structure in such a way that in plan view the main body and/or the electrode structure at least partially cover/covers the opening. The carrier structure may have multiple openings, in which case multiple main bodies and/or multiple electrode structures are disposed on the carrier structure in such a way that they in each case at least partially cover one of the openings. In the case of such an arrangement, multiple components with separate housing bodies can be produced simultaneously. In a departure from this, it is possible for the carrier structure to have no opening, in which case multiple main bodies each with an associated electrode structure are disposed alongside one another on the carrier structure, and multiple housing bodies at a spatial distance from one another are formed around the main bodies and/or around the electrode structures. In this way it is possible simultaneously to produce multiple components having separate housing bodies. A subsequent singulation of a joint housing body or of the components through a housing body is not necessary. The spatially separate housing bodies may be joined to a coherent electrode structure prior to the singulation of the components. The components in particular are singulated only through the coherent electrode structure. The housing bodies of the components or the housing body of an individual component may be free from singulation traces. The electrode structure of the component, however, may exhibit singulation traces.

According to at least one embodiment of the method, the housing body is formed on surfaces of the main body and/or on surfaces of the electrode structure. In particular, for forming the housing body on those surfaces of the main body that are facing the opening and/or on those surfaces of the electrode structure that are facing the opening, the photons are focused through the opening in the carrier structure. To form the housing body on those surfaces of the main body that are facing away from the opening and/or on those surfaces of the electrode structure that are facing away from the opening, the photons in particular are not focused through the opening in the carrier structure.

The radiations can be focused in this way from directions above or below the carrier structure onto points at which the housing body is to be formed. Particularly for electrode structures which have local indentations or elevations and therefore have angled or curved surfaces, the housing body can be produced with simplicity, great accuracy and reliability by means of the two-photon polymerization technique. Such electrode structures may be half-etched leadframes. In particular, the housing body borders the electrode structure and/or the main body in such a way that, between the housing body and the electrode structure and/or the main body, there are no interstices located that are filled with a gaseous medium for instance, such as with air, for example. The housing body therefore borders the electrode structure and/or the main body extensively and in particular without interruption, so enabling a particularly mechanically stable connection to be achieved between the housing body and the electrode structure and/or the main body. A component thus implemented has a particularly mechanically stable construction.

According to at least one embodiment of the method, the housing body is formed at the local points, focused by the radiations, in such a way that the housing body encloses the main body and/or the electrode structure in lateral directions over the full extent. It is possible for the housing body to cover all side faces of the main body, more particularly to cover them completely. In plan view, the main body may be completely covered by the housing body. It is possible, however, for the main body in plan view not to be covered by the housing body. The side faces of the main body may merely be regionally covered by the housing body.

According to at least one embodiment of the method, an outer layer is formed together with the housing body by means of two-photon lithography. In particular the outer layer has the form of a lens on the main body or the form of a ring around the main body. For example, the outer layer and the housing body are formed from the same material. The outer layer may be formed as an integral constituent of the housing body. In particular the housing body and the outer layer may be produced in the same operating step, such as in the same liquid solution, for example. The housing body and the outer layer may therefore form a coalesced unit. In this sense, the housing body may exhibit a seamless transition into the outer layer, so that there is no perceptible common interface between the housing body and the outer layer.

According to at least one embodiment of the method, an outer layer is formed by means of two-photon lithography subsequently directly on the housing body. In particular the outer layer has the form of a lens on the main body or the form of a ring around the main body. For example, the outer layer and the housing body are formed from different materials. The outer layer and the housing body may have different material compositions. It is possible for the housing body and the outer layer to be produced in different operating steps, such as in liquid solutions having different compositions, for example. The housing body and the outer layer in particular form two different constituents of the component, which may border one another directly. In this sense, the component may have a clearly perceptible, internal interface between the housing body and the outer layer.

According to at least one embodiment of the method, the housing body is produced without afterworking exclusively by polymerization and curing of the light-curing material. The housing body more particularly has a cavity in which the main body is disposed. The housing body is implemented in particular in one piece. The cavity is formed in particular by continual growth of the housing body at intended points. More particularly the cavity is not formed, for instance, by ablation of the material of the housing body. Additionally or alternatively to the cavity, the housing body in this context may have an outer layer as described above.

According to at least one embodiment of the method, the housing body is implemented in one piece. In particular the housing body is free from sublayers which for instance are disposed one above another and run parallel to one another. For example, the housing body is free from planar sublayers which are disposed one above another along the vertical direction. In other words, the housing body generated by two-photon lithography is not formed, for instance, by a layer sequence of thin, more particularly planar, sublayers which are arranged one above another and run parallel to one another.

According to at least one embodiment of the method, subregions of the housing body are initially formed at different points spatially separate from one another. Through focusing of the radiations it is possible for the subregions of the housing body that are spatially separate from one another to grow and ultimately to coalesce to form a unitary housing body. A housing body of this kind or a plurality of housing bodies of this kind may be produced using a single photon source. Alternative possibilities include using exactly two photon sources or multiple pairs of the photon sources simultaneously.

According to at least one embodiment of the method, photons from different photon sources are used. In particular the housing body is formed with the aid of the photon sources simultaneously at different points. In order to produce a plurality of components, the photon sources or the pairs of the photon sources may be used in succession or simultaneously to form a plurality of housing bodies, more particularly to form a plurality of housing bodies that are spatially separate from one another.

According to at least one embodiment of the method, a plurality of components are produced. The mutually separate main bodies of the components are formed, for example, alongside one another in the liquid solution. In particular, therefore, the main bodies of the adjacent components are not implemented coherently at any point in time. Since the individual housing bodies of adjacent components are at a spatial distance from one another during their actual production, there is no need for a singulation step through the housing body. The housing body thus has no singulation traces and/or no processing traces on its side faces, for instance. It is possible, however, for the components to be singulated through the electrode structure, more particularly exclusively through the electrode structure. The electrode structure with the first electrode and the second electrode of the component may therefore have singulation traces on its side face or on its side faces.

In at least one embodiment of a component, said component has a main body, an electrode structure configured for electrically contacting the main body, and a housing body bordering the main body and the electrode structure. In particular the housing body has a one-piece embodiment and directly borders both the main body and the electrode structure. For example, the housing body is free from external processing traces and/or free from planar internal sublayers that run parallel to one another and are ordered one above another.

In particular the component is a component produced according to at least one of the methods described here. The method described here is especially suitable for producing a component described here. The features described in connection with the method may therefore also be employed for the component, and vice versa.

### BRIEF DESCRIPTION OF THE DRAWINGS

Further preferred embodiments and refinements of the component and also of the method for producing a component are evident from the exemplary embodiments elucidated below in connection with FIGS. 1A to 5B, in which:

FIGS. 1A and 1B show schematic representations of a method for producing a component, and also schematic representation of a component;

FIGS. 2A and 2B show schematic representations of a comparative example of a component;

FIGS. 3A and 3B show schematic representations of a further exemplary embodiment of a component, in plan view and viewed in section; and

FIGS. 4A, 4B, 5A and 5B show schematic representations of further exemplary embodiments of a component, in each case in plan view and viewed in section.

### DETAILED DESCRIPTION OF ILLUSTRATIVE EMBODIMENTS

Identical, similar or equivalent elements in the figures are provided with identical reference signs. The figures are in each case schematic representations and therefore not necessarily true to scale. Instead it is possible for the size of comparatively small elements and, in particular, layer thicknesses to be represented with exaggeration for elucidation.

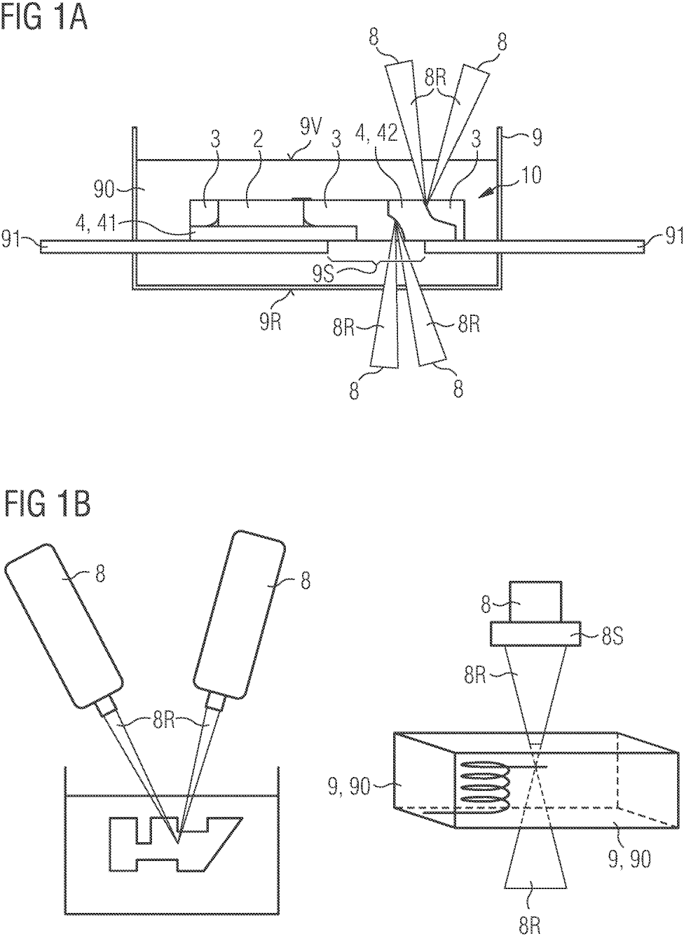

FIG. 1A shows a schematic representation of a method step for the production of a component 10. The component 10 has a main body 2 and an electrode structure 4. The electrode structure 4 is configured for electrically contacting the main body 2 and/or for electrically contacting the component 10. The electrode structure 4 has a first electrode 41 and a second electrode 42, with the electrodes 41 and 42 being assigned to different electrical polarities of the component 10.

In FIG. 1A the main body 2 is disposed on the first electrode 41 and has mechanical and electrically conducting connection to that electrode. The second electrode 42 is disposed to the side of the first electrode 41. In plan view, the main body 2 has no overlaps with the second electrode 42. The first electrode 41 has in particular an assembly face, on which the main body 2 is secured. In particular the main body 2 has direct electrically conducting connection to the first electrode 41. Via an electrical connection, for instance via a wire connection, which for reasons of clarity is not represented in FIG. 1A, the main body 2 can be electrically conductingly connected to the second electrode 42.

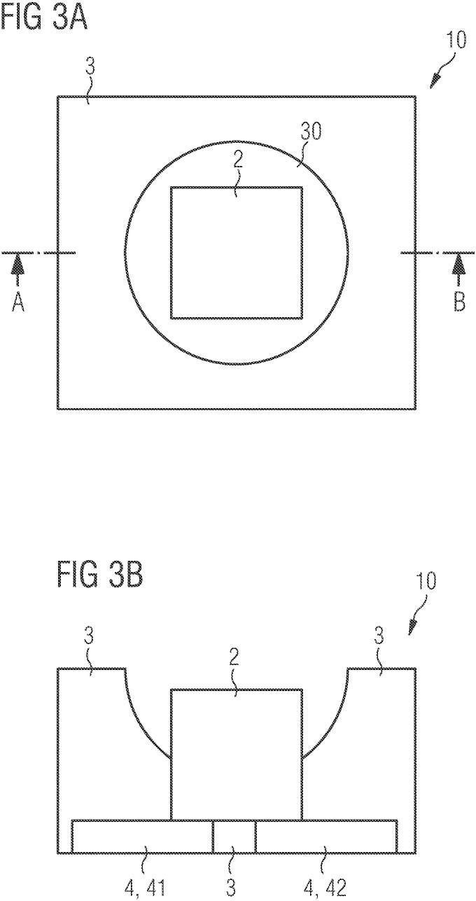

In a departure from FIG. 1A, it is possible for the main body 2 to be disposed both on the first electrode 41 and on the second electrode 42. In that case, in plan view, the main body 2 has overlaps both with the first electrode 41 and with the second electrode 42. This is represented schematically for example in FIGS. 3B, 4B and 5B. In particular, on its rear, the main body 2 has electrical connection points via which the main body 2 can be connected electrically conductingly — for instance, directly electrically conductingly — to the electrodes 41 and 42.

According to FIG. 1A, the electrode structure 4 and the main body 2 are disposed on a carrier structure 91. The carrier structure 91 is more particularly part of a container 9. In a departure from this it is possible for the carrier structure 91 to be a carrier structure 91 independent of the container 9. In other words, the carrier structure 91 may be firmly joined or not firmly joined to the container 9. The carrier structure 91 has an opening 9S. In plan view, the electrodes 41 and 42 each partially cover the opening 9S. In a departure from FIG. 1A, it is possible for the carrier structure 91 to have a plurality of openings 9S. In order to produce a plurality of components 10, it is possible for a plurality of electrode structures 4 and a plurality of main bodies 2 to be disposed on the carrier structure 91.

According to FIG. 1A, a housing body 3 is generated in the vicinity of the electrode structure 4 and of the main body 2. For this purpose the container 9 is filled up with a liquid solution 90. The filling of the container 9 with the liquid solution 90 may take place before the mounting or after the mounting of the main body 2 and of the electrode structure 4 in the container 9. The main body 2 and the electrode structure 4 are surrounded on all sides by the liquid solution 90. The liquid solution 90 comprises a light-curing material which solidifies under irradiation. In particular, the solution 90 contains base monomers of a photopolymer. The liquid solution 90 may be an acrylic resin, an epoxy resin or a vinyl ester resin solution. The solution may comprise initiators which on irradiation, more particularly on simultaneously absorption of two photons, trigger chain reactions for the formation of polymers from the base monomers.

FIG. 1A shows a method step for the formation of the housing body 3 by means of two-photon lithography, i.e., by means of two-photon polymerization technique. Such a technique is represented schematically for example in FIG. 1B.

The housing body 3 is manufactured by means of two-photon lithography, in which radiations 8R from two photon sources 8, more particularly two laser sources 8, are focused on targeted local points on the main body 2 and/or on the electrode structure 4. As a result, at the focused local points, the light-curing material located in the solution 90 is polymerized and cured to form the housing body 3. As a result of the focusing of the radiations 8R, the light-curing material is able to absorb two photons simultaneously, in particular from different photon sources. The two photon sources therefore provide sufficient energy to initiate the polymerization. The polymerization occurs in particular at the locations where the radiations are focused. Alternatively it is likewise possible in accordance with FIG. 1B to use a single photon source 8. The radiation 8R emitted by the photon source 8 may in particular be focused by means of an optical element 8S, for instance a lens, so that pairs of photons are absorbed simultaneously or substantially simultaneously at the focusing points. A focusing point of this kind is represented schematically in FIG. 1B on the right-hand side, at which polymer chains are formed. With this type of technology it is possible to form the housing body 3 in any desired shape and at any desired point.

If the main body 2 or the electrode structure 4 partially covers the opening 9S in the carrier structure 91, the housing body 3 may be formed by focusing of the radiations 8R directly from the front 9V of the container 9 or from the rear 9R of the container 9 through the opening 9S. This is represented schematically in FIG. 1A. According to FIG. 1A, the second electrode 42 is more particularly a structured — for instance, half-etched — leadframe. Such a leadframe has curved or angled surfaces, which in particular can be reached only from the front 9V or from the rear 9R of the container 9 without difficulties. In the case of two-photon lithography, the photon source 8 or the photon sources 8 may be disposed on the front 8V or on the rear 9R of the container 9 in order to establish the focusing points. The use of the photon source 8 or of the photon sources 8 from above and from below enables the curing of the housing material, which in particular, because of the curved or angled surfaces of the electrode structure 4, is unreachable or difficult to reach from below or from above.

According to FIG. 1A, the second electrode 42 has side faces with concave and convex curvature. Through suitable selection of the focusing sites, the housing body 3 can be formed in such a way that it directly borders the second electrode 42 at the curved or angled side faces as well. Along the vertical direction, the second electrode 42 may extend through the housing body 3. In lateral directions, the main body 2 and also the second electrode 42 are enclosed by the housing body 3 over the full extent. The first electrode 41 may also be enclosed by the housing body 3 in lateral directions over the full extent. It is possible for the housing body 3 completely to cover all side faces of the main body 2, of the first electrode 41 and/or of the second electrode 42.

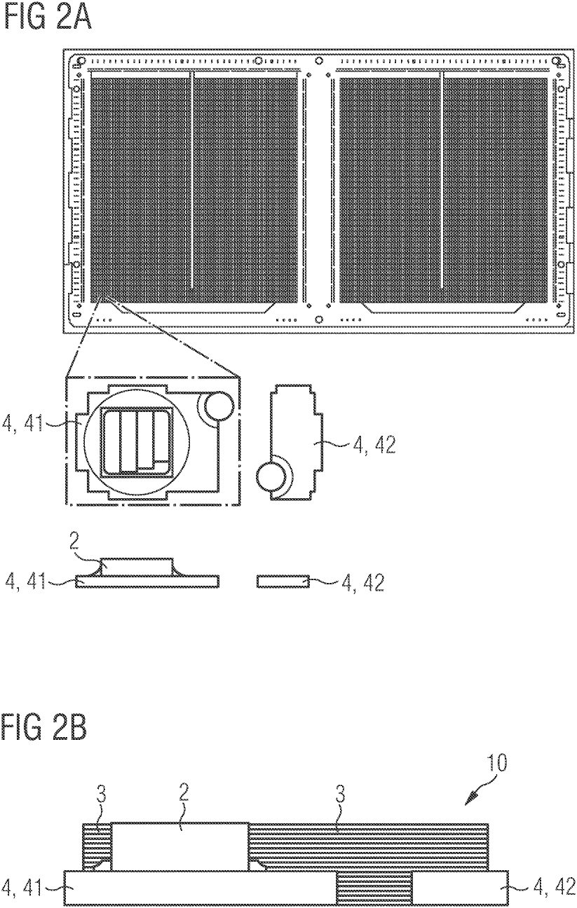

FIGS. 2A and 2B show a comparative example of a component 10 whose housing body 3 is produced in particular by means of standard lithography or by means of standard polymerization technique. With this technique, for example, a photon source is used for polymerizing the light-curing material, with the housing body 3 being lowered a bit deeper into the liquid after each step and being returned to a position in order to form a sublayer of the housing body 3.

In contrast to the situation with two-photon lithography, the housing body 3 generally has a layer sequence of multiple sublayers, more particularly planar sublayers disposed one above the other, which run parallel to one another. A housing body 3 of this kind is represented schematically in FIG. 2B. The housing body 3 according to FIG. 2B has around 20 to 30 planar sublayers disposed one above the other, each having a layer thickness in particular of between 10 µm and 20 µm inclusive.

By means of the two-photon lithography or the two-photon polymerization technique, it is possible to produce a housing body 3 which is free from a layer sequence —represented for instance in FIG. 2B — composed of a plurality of sublayers. The non-generation of multiple sublayers disposed one above another is especially advantageous when the height of the main body 2 is too large for the layer structure, for example, and the material located in the solution 90 is not evenly distributed.

The exemplary embodiment of a component 10 that is represented in FIGS. 3A and 3B corresponds substantially to the component 10 represented in FIG. 1A and can be produced by means of two-photon lithography. FIG. 3B shows the component 10 represented in FIG. 3A along the sectional plane AB. In contrast to FIG. 1A, the electrode structure 4 according to FIG. 3B has two substantially identical electrodes 41 and 42, which are each in electrically conductive connection to one of the connection points on the rear of the main body 2. In plan view, the electrodes 41 and 42, hence the entire electrode structure 4, are completely covered by the housing body 3. In lateral directions the electrode structure 4 is enclosed by the housing body 3, over the full extent.

As a further difference relating to FIG. 1A, the housing body 3 according to FIGS. 3A and 3B has a cavity 30 in which the main body 2 is disposed. In particular the housing body 3 protrudes beyond the main body 2 along the vertical direction. In the production of the component 10, the electrode structure 4 and the main body 2 may be disposed on the carrier layer 91 in such a way that the electrode structure 4 and the main body 2 at least partially or completely cover the opening 9S in the carrier structure 91. The housing body 3 in particular has a one-piece embodiment. The cavity 30 in particular is generated solely by the two-photon lithography, more particularly without the material of the housing body 3 being subsequently ablated to form the cavity 30. The outer faces of the housing body 3, for instance the outer faces of the cavity 30, in particular have no processing traces.

In a departure from FIG. 3B, it is possible for the cavity 30 to be filled up with a material which differs from the material of the housing body 3. For example, the cavity 30 is filled up with a filling layer composed in particular of a radiation-transparent material. In plan view, the filling layer may partially or completely cover the main body 2. The filling layer may be implemented in the form of a lens.

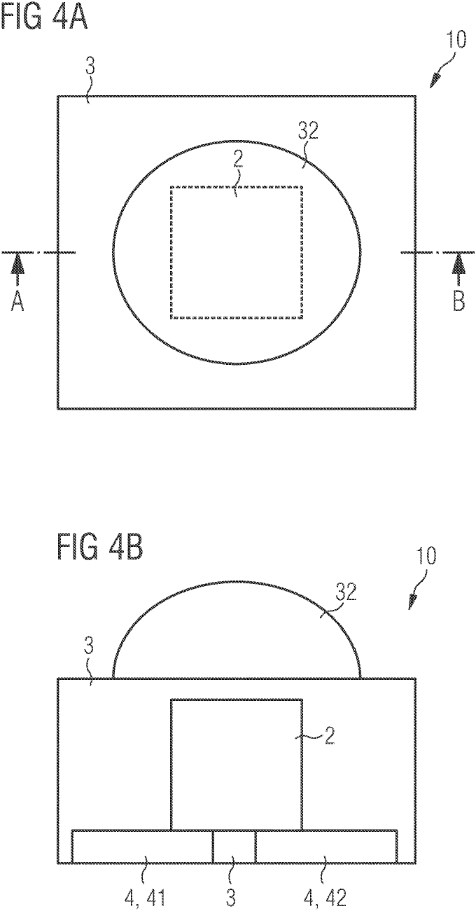

The exemplary embodiment of a component 10 that is represented in FIGS. 4A and 4B corresponds substantially to the component 10 represented in FIGS. 3A and 3B. FIG. 4B shows the component 10 represented in FIG. 4A along the sectional plane AB. In contrast to this, the housing body 3 has no open cavity. Instead, in plan view, the housing body 3 completely covers the main body 2. According to FIGS. 4A and 4B, the component 10 has an outer layer 32. The outer layer 32 has the form of a lens and in plan view completely covers the main body 2. The outer layer 32 may be formed of a radiation-transparent or radiation-opaque material.

The outer layer 32 is formed of a material which in particular differs from the material of the housing body 3. In this case an internal interface is apparent between the housing body 3 and the outer layer 32 in the completed component 10. The outer layer 32 may likewise be generated by means of two-photon lithography. For example, in the production of the outer layer 32, the liquid solution 90 differs in its material composition from that during the production of the housing body 3. In a departure from this it is possible for the housing body 3 and the outer layer 32 to be formed of the same material. For example, the housing body 3 and the outer layer 32 are produced during a joint operating step in the same liquid solution 90. In this case the housing body 3 and the outer layer 32 form a unit wherein the housing body 3 transitions seamlessly into the outer layer 32. Consequently there is no clearly perceptible internal interface located between the outer layer 32 and the housing body 3.

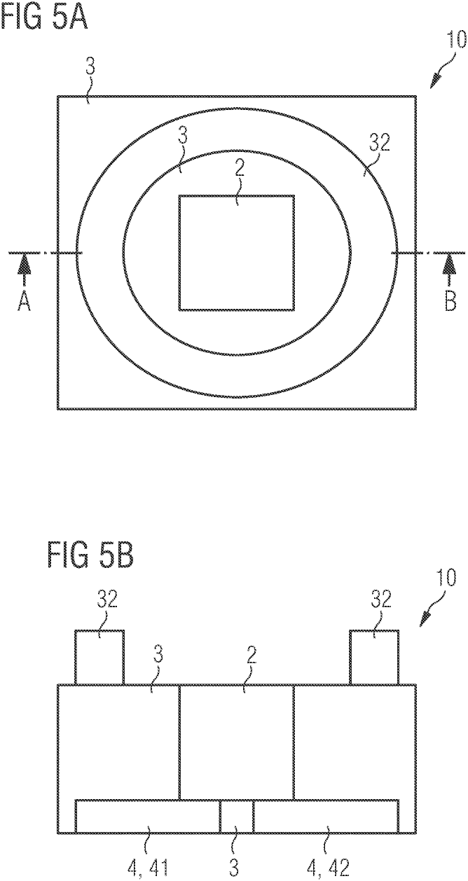

The exemplary embodiment of a component 10 that is represented in FIGS. 5A and 5B corresponds substantially to the component 10 represented in FIGS. 4A and 4B, with FIG. 5B showing the component 10 represented in FIG. 5A along the sectional plane AB. In contrast to FIGS. 4A and 4B, the housing body 3 finishes flush with the main body 2 along the vertical direction. In plan view, the main body 2 is free from any covering by the housing body 3. Instead of an outer layer 32 in the form of a lens, the component 10 represented in FIGS. 5A and 5B has an outer layer 32 in the form of a ring. The outer layer 32 projects beyond the main body 2 along the vertical direction. The outer layer 32 in the form of a ring has an opening, in plan view, in which the main body 2 is located. The outer layer 32 may be formed of a radiation-opaque, more particularly of a radiation-absorbing or radiation-reflecting, material.

In complete analogy to the exemplary embodiment represented in FIGS. 4A and 4B, the outer layer 32 and the housing body 3 according to the exemplary embodiment represented in FIGS. 5A and 5B may be formed of the same material or of different materials. Accordingly, the outer layer 32 and the housing body 3 may be produced during a common method step or in different method steps. In this connection, the features of a component 10 that are described with the FIGS. 4A and 4B, in particular in relation to the housing body 3 and the outer layer 32, can also be employed for the component 10 according to FIGS. 5A and 5B.

In summary, using the two-photon lithography, a housing body 3 can be produced in any desired shape and at any desired point of the main body 2 and/or of the electrode structure 4 in a simple way. In this case it is possible, for example, for the housing body 3 to have a cavity 30, a predefined pattern, hollow spaces or an outer layer 32 in any desired form. In particular it is possible for the outer layer 32 or the cavity 30 to be generated solely by means of the two-photon lithography and without ablation of material. The method may therefore be implemented with particular economy of material. This technology, furthermore, does not require any prefabricated molds or masks for the production of the housing body 3. The two-photon lithography, furthermore, permits particularly exact positioning of the housing body 3 in the component 10.

The description of the invention by means of the exemplary embodiments does not confine the invention to said embodiments. The invention instead embraces every new feature and also every combination of features, including, in particular, every combination of features in the claims, even if that feature or that combination is not itself explicitly indicated in the claims or exemplary embodiments.

1-16. (canceled)

17. A method for producing a component comprising a main body, an electrode structure configured for electrically contacting the main body, and a housing body bordering the main body and the electrode structure, the method comprising:
providing a container with a liquid solution located therein, wherein the liquid solution comprises a light-curing material, and wherein the main body and the electrode structure are disposed in the container and surrounded by the liquid solution; and
manufacturing the housing body by a two-photon lithography, in which photons are focused on targeted local points on the main body and on the electrode structure,
wherein the light-curing material is located in the solution being thereby polymerized and cured at the focused local points to form the housing body.

18. The method of claim 17, wherein the light-curing material comprises monomers of a light-curing polymer.

19. The method of claim 17, wherein the liquid solution is an acrylic resin, epoxy resin or vinyl ester resin solution.

20. The method of claim 17, wherein the main body and the electrode structure are completely surrounded by the solution, and wherein the housing body is formed without additional auxiliaries exclusively by focusing of the photons on targeted local points.

21. The method of claim 17, wherein a carrier structure is located in the container and has an opening, with the main body and the electrode structure being disposed on the carrier structure in such a way that in plan view the main body and/or the electrode structure cover/covers the opening at least partially.

22. The method of claim 21,
wherein the housing body is formed on surfaces of the main body and/or of the electrode structure,
wherein the photons are focused through the opening in the carrier structure when the housing body is formed on the surfaces of the main body and/or of the electrode structure that are facing the opening, and
wherein the photons are not focused through the opening in the carrier structure when the housing body is formed on the surfaces of the main body and/or of the electrode structure that are facing away from the opening.

23. The method of claim 17, wherein the housing body is formed at the local points focused by radiation such that the housing body encloses the main body and/or the electrode structure in lateral directions to a full extent.

24. The method of claim 17, wherein an outer layer is formed together with the housing body by the two-photon lithography, wherein the outer layer has a form of a lens on the main body or a form of a ring around the main body, and wherein the outer layer and the housing body are formed from the same material.

25. The method of claim 17, wherein an outer layer is formed by the two-photon lithography subsequently directly on the housing body, wherein the outer layer has a form of a lens on the main body or a form of a ring around the main body, and wherein the outer layer and the housing body are formed from different materials.

26. The method of claim 17, wherein the housing body is produced without subsequent processing exclusively by polymerization and curing of the light-curing material such that the housing body has a cavity in which the main body is disposed.

27. The method of claim 17, wherein the housing body is one piece and is free from sublayers which are disposed one above another and run parallel to one another.

28. The method of claim 17, wherein subregions of the housing body are formed initially at different points spatially separate from one another, and wherein the subregions of the housing body that are spatially separate from one another grow by focusing of radiations and ultimately coalescing to provide the unitary housing body.

29. The method of claim 17, wherein photons from different photon sources are used, and wherein the housing body is formed simultaneously at different points by the different photon sources.

30. The method claim 17, wherein a plurality of components are produced, and wherein the main bodies of the components are formed separately alongside one another in the liquid solution and therefore are not coherently implement at any point in time.

31. The component produced by the method of claim 17, wherein the housing body is one piece, directly borders the main body and directly borders the electrode structure.

32. The component of claim 31, wherein the housing body is free from external processing traces and/or free from planar internal sublayers which run parallel to one another and are arranged one above another.

33. A method for producing a component comprising a main body, an electrode structure configured for electrically contacting the main body and a housing body bordering the main body and the electrode structure, the method comprising:
providing a container with a liquid solution located therein, wherein the liquid solution comprises a light-curing material, and wherein the main body and the electrode structure are disposed in the container and surrounded by the liquid solution; and
focusing, by a two-photon lithography, photons on targeted local points on the main body and on the electrode structure thereby polymerizing and curing the solution, and forming the housing body.

34. The method of claim 33, wherein the main body and the electrode structure are completely surrounded by the solution, and wherein the housing body is formed exclusively by focusing of the photons on targeted local points.

35. The method of claim 33, wherein the light-curing material comprises monomers of a light-curing polymer.
